(19) United States
(12) Patent Application Publication
(10) Pub. No.: US 2007/0201818 A1
(43) Pub. Date: Aug. 30, 2007

(54) Method and apparatus for searching for frame of moving picture using key frame

(75) Inventors: Hyun-Seok Choi, Seoul (KR); Choon-Kyoung Moon, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/644,876

(22) Filed: Dec. 26, 2006

(30) Foreign Application Priority Data
Feb. 18, 2006 (KR) 2006-15912

(51) Int. Cl. H04N 5/91

(52) U.S. Cl. 386/68

(57) ABSTRACT

A method and apparatus for searching for a frame of a moving picture are provided. The method includes setting a start position for searching, searching bidirectionally for key frames starting at the start position; decoding the searched key frames, and displaying the decoded key frames on multiple screens, wherein the key frames displayed on the multiple screens are key frames searched at corresponding positions from the search start position. The method and apparatus enable a user to search for a frame of a moving picture easily and quickly by searching for a key frame by using multiple screens.

### CROSS-REFERENCE TO RELATED APPLICATIONS

This application claims all benefits accruing under 35 U.S.C. § 119 from Korean Patent Application No. 2006-15912, filed on Feb. 18, 2006, in the Korean Intellectual Property Office, the disclosure of which is incorporated herein by reference.

### BACKGROUND OF THE INVENTION

1. Field of the Invention

Aspects of the present invention relate to a method and apparatus for searching for a frame of a moving picture, and more particularly, to a method and apparatus for searching for a frame of a moving picture enabling a user to search for a key frame using a multiple screen display and thereby enabling the user to search for the frame of the moving picture easily and quickly.

2. Related Art

A method of searching for a frame of a moving picture in conventional Windows Media Player or RealPlayer is to scan the whole contents of a moving picture by moving a play scroll bar indicating the progress of playing or to use a fast forward button. However, there are problems with these methods in that a user has difficulty in searching for a desired position of the moving picture and that the whole content of the moving picture is hard to scan quickly.

### SUMMARY OF THE INVENTION

The present invention provides a method and an apparatus for searching for a frame of a moving picture easily and quickly by searching for key frames by using multiple screens.

Additional aspects and/or advantages of the invention will be set forth in part in the description which follows and, in part, will be obvious from the description, or may be learned by practice of the invention.

According to an aspect of the present invention, there is provided a method of searching for a frame of a moving picture comprising setting a start position for searching; searching bidirectionally for key frames starting at the start position; decoding the key frames found; and displaying the decoded key frames on multiple screens, wherein the key frames displayed on the multiple screens are key frames found at corresponding positions from the search start position.

According to another aspect of the present invention, the search start position is set by an input signal from a user or set to a predetermined position in advance.

According to another aspect of the present invention, there is provided a method of searching for a frame of a moving picture comprising setting a predetermined number of search start positions; searching for a key frame in a predetermined search direction starting at the predetermined number of search start positions; decoding the key frames found based on the starting positions and the search direction; and displaying the decoded key frames on the multiple screens having a same number of screens as the number of search start positions.

According to another aspect of the present invention, the setting of the search start positions is performed using a value resulting from dividing the total number of the key frames included in the moving picture by the number of search start positions.

According to another aspect of the present invention, there is provided an apparatus for searching for a frame of a moving picture comprising a user input receiving unit receiving an input signal from a user for setting search information; a storage unit storing a file of the moving picture including key frames; a control unit searching for a key frame based on the set search information; a decoder decoding the key frames found; and a multiple screen output unit configuring the found key frames as screens so as to be displayed on multiple screens and outputting the configured screens as the screen, wherein the search information includes at least one of a search mode indicating a bidirectional search or a multiple search, a search start position, a search direction, and wherein the control unit searches for key frames starting at the start position bidirectionally or starting at a predetermined number of search start positions in a predetermined search direction.

In addition to the exemplary embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIGS. 1A and 1B are diagrams illustrating a method of bidirectional searching for a frame of a moving picture using a key frame according to an example embodiment of the present invention;

FIGS. 2A and 2B are diagrams illustrating a method of multiple searching for a frame of a moving picture using a key frame according to another example embodiment of the present invention;

FIG. 3 is a diagram illustrating an apparatus for searching for a frame of a moving picture using a key frame according to an example embodiment of the present invention;

FIG. 4 is a flowchart illustrating a method of bidirectional searching for a frame of a moving picture using a key frame according to an example embodiment of the present invention; and

FIG. 5 is a flowchart illustrating a method of multiple searching for a frame of a moving picture using a key frame according to another example embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

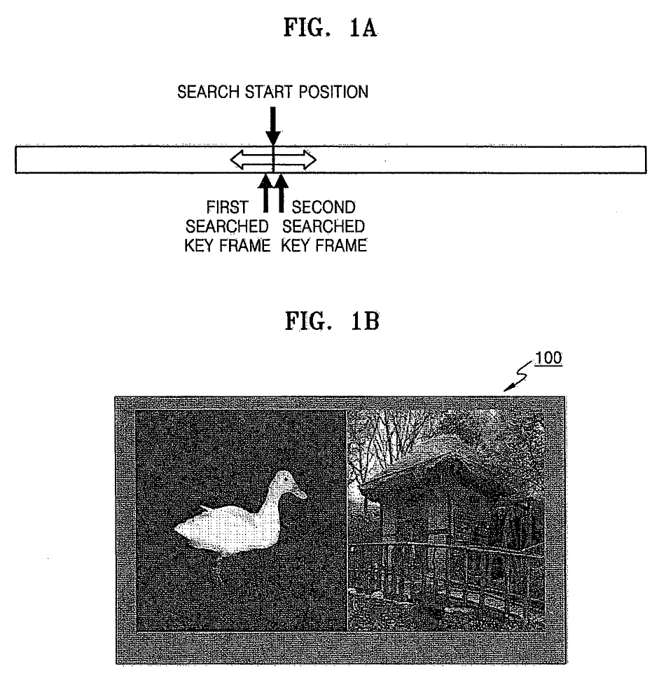

FIGS. 1A and 1B are diagrams illustrating a method of bidirectional searching for a frame of a moving picture using a key frame according to an example embodiment of the present invention. When a start position for searching is set by an input signal from a user or set to a predetermined position in advance, an apparatus for searching for a frame of a moving picture searches bidirectionally for key frames from the search start position, as illustrated in FIG. 1A. A key frame may be a frame selected and searched for by a user, by a technique such as encoding a moving picture by adding key frame indicators, frames decodable without referring to a different frame. Accordingly, the key frame can be searched for by searching for the added key frame indicator. Other aspects of the present invention may use other techniques to select key frames.

As illustrated in FIG. 1A, the first and second key frames found are decoded. The decoded first and second key frames found are processed for multiple screens and displayed on multiple screens 100, as illustrated in FIG. 1B. The key frames displayed on the multiple screens 100 are key frames found at corresponding positions from the search start position, as illustrated in FIG. 1A.

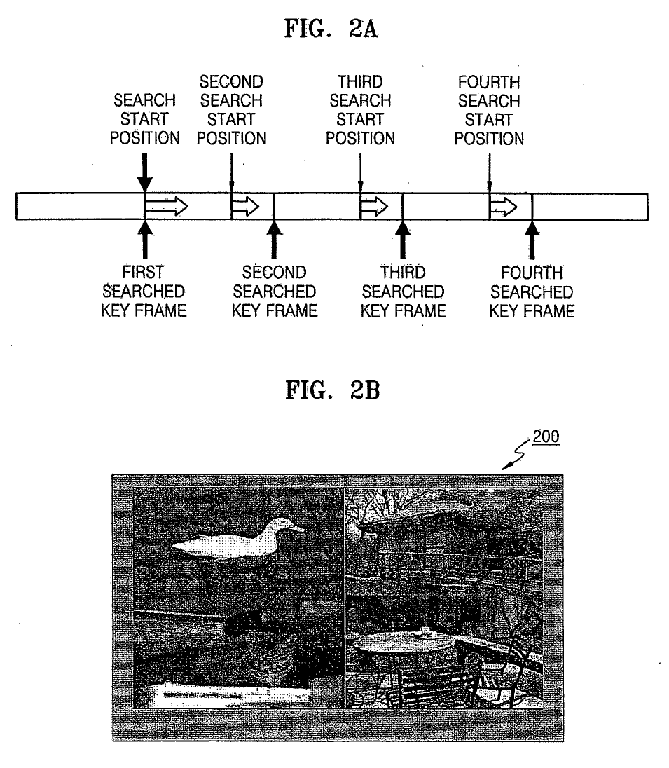

FIGS. 2A and 2B are diagrams illustrating a method of multiple searching for a frame of a moving picture using a key frame according to another example embodiment of the present invention. Two or more predetermined numbers of start positions can be set, from where searching starts. FIG. 2A illustrates a process of searching from four start positions in a forward direction. Other aspects of the present invention may search in a backward direction or bidirectionally from the start positions.

As illustrated in FIG. 2A, key frames which are first, second, third, and fourth key frames for searching are searched from each start position along a predetermined direction of searching. The key frames found are decoded, and the decoded key frames may be displayed on multiple screens 200 having the same number of screens as the number of search start positions, in this case four, as illustrated in FIG. 2B. The multiple screens 200 may be displayed on different display units, or all the screens may be displayed on the same display unit. The number of search start positions and the direction of searching from the start positions may be set by the input signal from the user or set to a predetermined value. Alternatively, when multiple search start positions are set, the start positions may be set by setting a search interval to a value resulting from dividing the total number of the found key frames of the moving picture by the number of search start positions set.

FIG. 3 is a diagram illustrating an apparatus for searching for a frame of a moving picture using a key frame according to an example embodiment of the present invention. The apparatus includes a user input receiving unit 310, a control unit 320, a storage unit 330, a decoder 340, and a multiple screen output unit 350. The apparatus in the embodiment may be implemented by a digital TV, a personal video recorder (PVR), a portable multimedia player (PMP), or any device capable of displaying or storing video.

The user input receiving unit 310 receives, from a user input device (such as a touch screen or a keypad,) a user input signal for a request to search for a frame of the moving picture or to set search information, including a search mode indicating a bidirectional search or a multiple search, a search start position, a search direction, and the like. The search information may be set in the apparatus in advance or set and/or changed according to the user input signal. A file of the moving picture is stored in the storage unit 330. A key frame to which a key frame indicator is added may be included in the stored file of the moving picture. However, the present invention is not limited thereto, and in the storage unit 330, the file of the moving picture may be stored in various formats having structures in which a key frame can be searched, such as Windows Media Video, RealVideo, or Quicktime. The storage unit 330 may be implemented by a storage medium providing random access, such as a hard disk drive (HDD).

The control unit 320 analyzes the user input signal to determine whether the user input signal received from the user input receiving unit 310 is for searching for a frame of the moving picture or for setting the search information. The control unit 320 controls the storage unit 330, the decoder 340, and the multiple screen output unit 350 based on the result of the determination. When the user input signal for searching for a frame of the moving picture is input, and when the search mode is a bidirectional search mode, the control unit 320 searches bidirectionally for key frames from the start position and can search for corresponding key frames from the search start position. On the other hand, when the search mode is multiple search mode, the control unit 320 searches the storage unit 330 for the same number of key frames as the number of search start positions from a predetermined number of start positions in a predetermined direction based on the set search information. In other aspects, the control unit 320 may combine the bidirectional search and multiple search modes by searching bidirectionally from each of the start positions.

The decoder 340, under the control of the control unit 320, decodes key frames found. The multiple screen output unit 350 configures the decoded key frames as multiple screens 100 or 200 (depending on the search mode) matching the resolution and size of the display device and outputs the configured key frames. When the search mode is the bidirectional search mode, the key frames output from the multiple screen output unit 350 may be provided as illustrated in FIG. 1B. When the search mode is the multiple search mode, and the number of search start positions is set to four, multiple screens as illustrated in FIG. 2B may be provided. In the multiple search mode, the number of screens may match the number of search start positions.

As explained above, when a selection signal for the found key frames provided as the multiple screens 100 or 200 is received from the user input receiving unit 310, the control unit 320 controls the decoder 340, so that the moving picture is played from the selected key frame.

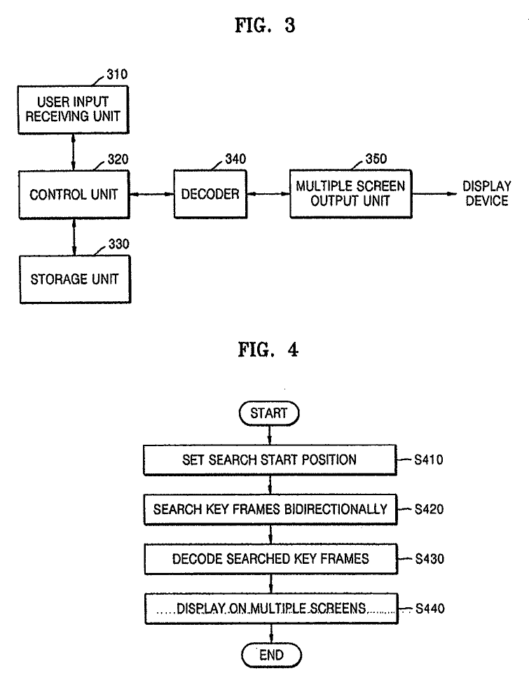

FIG. 4 is a flowchart illustrating a method of bidirectional searching for a frame of a moving picture using a key frame according to an example embodiment of the present invention.

When a search start position is set by an input signal from a user or set to a predetermined position in advance (operation S410), the control unit 320 bidirectionally searches the storage unit 330 for a key frame, starting at the start position (operation S420) and controls the decoder 340 to decode the key frames found (operation S430). The decoded key frames are configured and output as multiple screens 100 by the multiple screen output unit 350, and the multiple screens output are displayed on the display device (operation S440). The key frames displayed on the multiple screens 100 are key frames found at corresponding positions from the search start position.

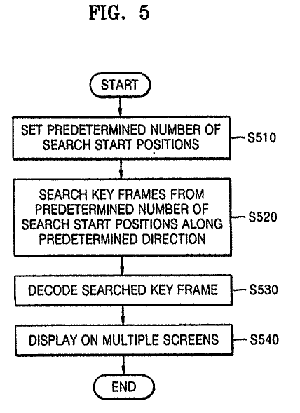

FIG. 5 is a flowchart illustrating a method of multiple searching for a frame of a moving picture using a key frame according to another example embodiment of the present invention.

A predetermined number of search start positions are set by an input signal from a user or set to predetermined positions in advance (operation S510). The start positions may be set using a value resulting from dividing the total number of key frames of the moving picture by a predetermined number of search start positions. Then, the control unit 320 searches for the key frames from the storage unit 330 in a predetermined direction, starting at the predetermined start positions (operation S520). The decoder 340, under the control of the control unit 320, decodes the key frames found, starting at the start positions in the search direction (operation S530). The decoded key frames are configured and output by the multiple screen output unit 350 as multiple screens 200 having the same number as the number of start positions for searching, and the multiple screens output are displayed on the display device (operation S540).

The invention can also be embodied as computer readable codes on a computer readable recording medium. Also, functional programs, codes, and code segments for accomplishing the present invention can be easily construed by programmers skilled in the art to which the present invention pertains. The computer readable recording medium may be any data storage device that can store data which can be thereafter read by a computer system. Examples of computer readable recording media include read-only memory (ROM), random-access memory (RAM), CD-ROMs, magnetic tapes, floppy disks, optical data storage devices, and carrier waves such as data transmission through the Internet. The computer readable recording medium can also be distributed over network coupled computer systems so that the computer readable code is stored and executed in a distributed fashion.

As explained above, according to a method and apparatus of the present invention, searching for a frame of a moving picture can be performed easily and quickly by using bidirectional searching or multiple searching for key frames and by providing the searched key frames on multiple screens.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the bidirectional search and multiple search modes may be combined so that at least two simultaneous searches are performed from at least one start position.

In addition, various components of the apparatus shown in FIG. 3, such as the control unit 320, the decoder 340, and the multiple screen output unit 350, can be integrated into a single control unit, or alternatively, can be implemented in software or hardware, such as a field programmable gate array (FPGA) and an application specific integrated circuit (ASIC). As such, it is intended that the processes described herein, including those shown in FIG. 4 and FIG. 5, be broadly interpreted as being equivalently performed by software, hardware, or a combination thereof. Software modules can be written in a variety of software languages, including C, C++, Java, Visual Basic, and others.

Accordingly, it is intended, therefore, that the present invention not be limited to the various example embodiments disclosed, but that the present invention includes all embodiments falling within the scope of the appended claims.

What is claimed is:

1. A method of searching for a frame of a moving picture comprising:
setting a start position for searching;
searching bidirectionally for key frames of a moving picture starting at the start position;
decoding the key frames found; and
displaying decoded key frames on multiple screens;
wherein the key frames displayed on the multiple screens are key frames searched at corresponding positions from the search start position.

2. The method according to claim 1, wherein the search start position is set by an input signal from a user.

3. A method of searching for a frame of a moving picture comprising:
setting a predetermined number of search start positions;
searching for key frames in a predetermined search direction starting at the predetermined number of search start positions;
decoding the key frames found based on the starting positions and the search direction; and
displaying decoded key frames on the multiple screens having a same number of screens as the number of search start positions.

4. The method according to claim 3, wherein the setting of the search start positions is performed using a value resulting from dividing the total number of the key frames included in the moving picture by the number of search start positions.

5. An apparatus for searching for a frame of a moving picture comprising:
a user input receiving unit arranged to receive an input signal from a user for setting search information;
a storage unit to store a file of the moving picture including key frames;
a control unit arranged to search for a key frame based on the set search information;
a decoder to decode the key frames found; and
a multiple screen output unit to configure the found key frames as screens so as to be displayed on multiple screens and to output the configured screens as the screen;
wherein the search information includes at least one of a search mode indicating a bidirectional search or a multiple search, a search start position, a search direction; and
wherein the control unit searches for key frames starting at the start position bidirectionally or starting at a predetermined number of search start positions in a predetermined search direction based on the search information.

6. The method according to claim 1, wherein the search start position is set to a predetermined position in advance.

7. The method according to claim 1, wherein the key frames comprise a key frame indicator.

8. The method according to claim 3, wherein the key frames comprise a key frame indicator

9. The apparatus according to claim 5, wherein the key frames comprise a key frame indicator.

10. A method of searching for a frame of a moving picture, comprising:
setting at least one start position for searching;
performing at least two simultaneous searches for key frames from the at least one start position;
displaying simultaneously on at least one screen all key frames found.

11. The method according to claim 10, wherein the key frames comprise a key frame indicator.

12. An apparatus for searching for a frame of a moving picture, comprising:
a control unit to search for a key frame by performing at least two simultaneous searches from at least one start position; and
a multiple screen output unit to configure the key frames found by the control unit so as to simultaneously display the key frames on multiple screens.

13. The apparatus according to claim 12, wherein the key frames comprise a key frame indicator.

14. The apparatus according to claim 12, wherein the control unit is further configured to:
set a search start position;
search bidirectionally for key frames of the moving picture starting at the start position;
decode the key frames found; and
control the visual display of the decoded key frames by the multiple screen output unit.

15. The apparatus according to claim 12, wherein the control unit is further configured to:
set a predetermined number of search start positions;
search for key frames in a predetermined search direction starting at the predetermined start positions;
decode the key frames found based on the starting positions and the search direction; and
control the visual display of the decoded key frames by the multiple screen output unit.

16. An apparatus comprising:
a display unit to provide a visual display of a moving picture; and
a control unit configured to set at least one start position for searching, to perform at least two simultaneous searches, from the at least one start position, for a plurality of key frames of the moving picture, and to control the visual display, by the display unit, of the plurality of key frames on multiple screens.

17. The apparatus of claim 16, wherein the control unit is further configured to:
set a search start position;
search bidirectionally for the plurality of key frames starting at the start position;
decode the key frames found; and
control the visual display, by the display unit, of the key frames found on multiple screens.

18. The apparatus of claim 16, wherein the control unit is further configured to:
set a predetermined number of search start positions;
search for the plurality of key frames in a predetermined search direction starting at the predetermined search positions;
decode the key frames found based on the starting positions and the search direction; and
control the visual display, by the display unit, of the key frames found on multiple screens.

19. The apparatus of claim 16, wherein the at least one search start positions are determined by an input signal from a user or set to predetermined positions in advance.

20. The apparatus of claim 16, wherein each of the plurality of key frames comprise a key frame indicator.
